(19) United States
(12) Patent Application Publication
(10) Pub. No.: US 2010/0023404 A1
(43) Pub. Date: Jan. 28, 2010

(54) SYSTEMS AND METHODS FOR DISPLAYING AND MANAGING SHOWROOM ITEMS

(76) Inventors: Daniel R. Elgort, New York, NY (US); Scott T. Denegre, New York, NY (US); Shanon V. Levenherz, New York, NY (US)

Correspondence Address: LONDA, BRUCE S.;NORRIS MCLAUGHLIN & MARCUS, PA, 875 THIRD AVE, 8TH FLOOR, NEW YORK, NY, 10022, US

(21) Appl. No.: 12/503,133

(22) Filed: Jul. 15, 2009

Related U.S. Application Data
(60) Provisional application No. 61/082,970, filed on Jul. 23, 2008.

(51) Int. Cl. G06Q 30/00

(52) U.S. Cl. 705/14.64; 705/27

(57) ABSTRACT

Systems and methods display and manage showroom items of a vendor. A first computer terminal is connected to a wireless communication network and programmed with automatic updating software to update information and/or multimedia data indicative of the showroom items. The systems and methods include a digital line sheet having a display, a memory and a first wireless transducer connected to a microprocessor. The first wireless transducer is connectable to the first communication network such that the digital line sheet communicates with the first computer terminal via the first communication network. The display of the digital line sheet renders the information and/or multimedia data received from the first computer terminal over the wireless communication network. The first computer terminal automatically updates the information and/or multimedia data accessible by the digital line sheet to be indicative of one or more available showroom items of the vendor. The systems and methods enable a buyer to use the digital line sheet in a showroom of a vendor to access information about the showroom items and to record notes and preferences pertaining to the showroom items. An order can be prepared and finalized using the digital line sheet in the showroom or subsequently from a remote computer terminal via a website of the vendor.

### CROSS REFERENCE TO RELATED APPLICATION

This application claims the benefit of U.S. Provisional Application No. 61/082,970 filed Jul. 23, 2008, incorporated by reference herein.

### BACKGROUND

The present disclosure is related to systems and methods for displaying and managing showroom items. More specifically, the systems and methods for managing and displaying showroom items may have one or more wireless digital line sheets and/or remote computer terminals which may be capable of connecting to a vendor computer terminal and a server for accessing a database over a communication network. Information displayable by the one or more wireless digital line sheets may be updated and/or configured by the vendor computer terminal in real-time to provide accurate information regarding available showroom items, pending orders and/or showroom vendors. Users may utilize the wireless digital line sheets to view item information indicative of or associated with the available showroom items. A location of the available items in a showroom may be provided to the wireless digital line sheets so that the users may locate and inspect the available items in a showroom of the vendor. The systems and methods may include a proximity sensor in communication with the wireless digital line sheets for providing directions to the locations of the available showroom items based on a detected location of the wireless digital line sheets.

The users may customize digital images of the showroom items by changing the colors of the items via the wireless digital line sheets. The users may enter personal information regarding the user and/or one or more available showroom items into a digital user profile via the wireless digital line sheets, a wireless handheld device and/or a computer terminal. The digital user profile may be accessible via a website for entering, updating and/or storing personal information associated with the digital user profile. The personal information and/or digital user profile may be stored in the database and accessed by the remote computer terminal of the user and/or the wireless digital line sheets. The information of the users may include notes, opinions, reviews and/or comments regarding the available showroom items. The users may create digital mannequins via the wireless digital line sheets or the remote computer terminals to simulate ensembles comprised of showroom items and to provide multiple poses of the digital mannequins and/or motion of the digital mannequins. The users may finalize orders for one or more available showroom items via the wireless digital line sheets and/or the remote computer terminals of the users. Moreover, the systems and methods may provide electronic notifications and/or advertising media that may be displayable via the wireless digital line sheets, the vendor computer terminal and/or the remote computer terminals of the users.

It is generally known, for example, that a wholesale vendor and/or a manufacturer (hereinafter “vendor”) in the garment or fashion industry utilizes a preprinted paper wholesale sales sheet, such as a preprinted paper line sheet to provide garment item information to buyers. The paper line sheet provides information regarding garment items which includes available sizes, a size range, a line, an identification number, a style, available colors, prices, order cutoff dates, delivery information and/or the like. In addition to the line sheet, the vendor also provides a handheld swatch card and a preprinted paper order form to the buyers. The garment items may be available in different colors and/or different fabrics which may be identified with the handheld swatch card. The buyers examine the swatch card to identify a specific color and/or fabric which may be listed on the paper line sheet for the garment items. Moreover, the buyers must complete the order form and forward the order form to the vendor to complete and finalize an order for the garment items. Preparation of a preprinted paper line sheet and order form along with a handheld swatch card for each buyer requires a larger amount of time and great expense from the vendor.

Traditionally, the vendor must provide each buyer with a preprinted paper line sheet, swatch card and order form so that the buyer may identify a desired garment items in a showroom of the vendor, determine characteristics of the desired garment items and finalize an order for the desired garment items. Often, one or more garment items of a vendor may become unavailable after preparation of the preprinted paper line sheet, swatch card and/or order form because of a low inventory of or a high demand for the garment items. However, preprinted paper line sheets, swatch cards and/or order forms of the vendor may still include the unavailable garment items because the preprinted paper line sheets, swatch cards and/or order forms were prepared when the garment items were still available. Additionally, one or more garment items of the vendor may not have been prepared and/or ready for display at the time when the paper line sheets, swatch cards and/or order forms were prepared and printed. Moreover, one or more garment items of the vendor may have been modified, such as, for example, different colors and/or sizes of the one or more garment items may become available after the preparing and/or printing of the paper line sheets, swatch cards and/or order forms.

In order to update the preprinted paper line sheets, swatch cards and/or order forms, the vendor must update the line sheets and/or order forms and copy or reprint the updated paper line sheets, swatch cards and/or order forms for distribution to each buyer so that the paper line sheets, swatch cards and/or order forms accurately include current, available garment items of the vendor. Thus, updating and copying or reprinting paper line sheets, swatch cards and/or order forms to accurately reflect the available garment items of the vendor is a timely and costly procedure. Additionally, it is often difficult to communicate updated paper line sheets, swatch cards and/or order forms to buyers that have already visited the showroom and had received inaccurate and/or outdated line sheets, swatch cards and/or order forms.

Traditionally, the buyers may view the garment items of the vendor and complete the order forms while in the showroom of the vendor. Alternatively, a buyer may completed the order form outside the showroom at, for example, the buyer's office after visiting the showroom of the vendor. The buyer may consult buyer's notes made during the visit to the showroom of the vendor prior to completing the order form and/or finalizing the order form. By doing so, the buyers may physically inspect the garment items to determine which garment items to purchase from the vendor based on physical appearance and/or attributes of the garment items. Even after inspecting the garment items, the buyers may seek additional information to determine which garment items to purchase. Other buyers may be unable to visit the showroom of the vendor to view the garment items in person and may only review the description information provided in the paper line sheets and order forms to determine which garment items to purchase.

However, the preprinted paper line sheets and/or the order forms may not provide the description and additional information need by the buyers to make a final purchasing decision. As a result, the buyers may refuse to purchase the garment items from the vendor because the vendor has not provided sufficient information to the buyer regarding the garment items. Moreover, one or more errors or unclear entries may be entered by the buyers during completion of the order forms which may result in delivery of incorrect garment items to the buyers and/or unsatisfactory services being rendered by the vendor.

Often, buyers flip back and forth between the paper line sheets and order forms and the handheld swatch cards to access and identify the necessary information to prepare and finalize an order of the garment items. As a result, the buyer may experience difficulty and frustration attempting to match the information for a garment items on the paper line sheet, the order form and the swatch card for successfully completing the order forms. Thus, utilizing the paper line sheet and order form with the handheld swatch card is inconvenient and time consuming for the buyers.

A need, therefore, exists for systems and methods for displaying and managing showroom items which may provide an electronic digital line sheet to display showroom item information which may be updated and configured by a computer terminal in real-time via a communication network. Further, a need exists for systems and methods for displaying and managing showroom items which may display sufficient showroom item information to a user via an electronic digital line sheet so that the user may make a final purchasing decision based on the displayed showroom item information. Still further, a need exists for systems and methods for displaying and managing showroom items which may minimize ordering errors by allowing the user to finalize and place an order for showroom items via an electronic digital line sheet or a remote computer terminal of the user. Moreover, a need exists for systems and methods for displaying and managing showroom items which may easily and conveniently allow creation of a user profile to view showroom item information and place orders for the showroom items.

### SUMMARY

Systems and methods for managing showroom items may have an electronic digital line sheet (hereinafter “line sheet”) capable of connecting to a vendor computer terminal, a server and/or a database via a wireless communication network. The line sheet may be updated and/or configured by the vendor computer terminal in real-time to reflect available showroom items and/or current showroom inventories (hereinafter “showroom items”). The line sheet may display item information indicative of the showroom items which may include images of the available items in multiple colors and locations of the showroom items in a showroom of the vendor. The systems and methods may include a proximity sensor in communication with a wireless transducer of the line sheet for providing directions to the locations of the available showroom items based on a location of the line sheet in the showroom.

A user of the line sheet may create and store a user profile within the database for maintaining and/or updating user information including a list of desired showroom items and showroom items of interest and/or personal information regarding the desired showroom items and/or the showroom items of interest. The user may create and/or manipulate a digital mannequin to simulate ensembles of the showroom items in multiple colors. The user may access the user profile via the line sheet and/or remote computer terminal of the user to view and/or update the user information and personal information. The user may finalize an order for available items of the showroom via the line sheet and/or the remote computer terminal of the user. Moreover, the systems and methods may provide electronic notification and/or advertising media which may be displayed and/or rendered by the line sheets, the vendor computer terminal and/or the remote computer terminal of the user.

In an embodiment of the present invention, a system for displaying and managing showroom items in a showroom of a vendor is provided. The system may have a first computer terminal connected to a first communication network, wherein the first communication network is a wireless communication network, wherein the first computer terminal is programmed with automatic updating software and accesses information and/or multimedia data indicative of the showroom items. Moreover, the system may have a digital line sheet having a display, a memory and a first wireless transducer connected to a microprocessor, wherein the first wireless transducer is connectable to the first communication network such that the digital line sheet communicates with the first computer terminal via the first communication network, wherein the display of the digital line sheet renders the information and/or multimedia data received from the first computer terminal over the wireless communication network.

In embodiments, the system may have a second computer terminal connected to the first computer terminal via a second communication network, wherein the second computer terminal is remote with respect to the first computer terminal and the digital line sheet.

In embodiments, the system may have a sensor located within the showroom of the vendor and connected to the first communication network, wherein the sensor detects a location of the digital line sheet within the showroom of the vendor.

In embodiments, the system may have a second wireless transducer connected to the microprocessor of the digital line sheet, wherein the second wireless transducer communicates with the sensor within the showroom of the vendor.

In embodiments, the second wireless transducer and/or the sensor may be an infrared communication device, a radio frequency identification tag, radio frequency identification reader, a Smart Card or a Smart Card reader.

In embodiments, the system may have a server and a database in communication with the first computer terminal via a second communication network.

In embodiments, the system may have advertising media accessible by the first computer terminal, wherein the advertising media is rendered by the digital line sheet, the first computer terminal or the second computer terminal.

In embodiments, the system may have location directions for a showroom item within the showroom are transmitted from the first computer terminal to the digital line sheet via the first communication network.

In embodiments, the system may have an electronic notification transmitted from the first computer terminal to the digital line sheet or the second computer terminal, wherein the electronic notification is indicative of one or more showroom items, a finalized order, a user profile, an event, a promotion or the vendor.

In embodiments, the system may have a finalized order for one or more showroom items, wherein the finalized order is transmitted to the first computer terminal from the digital line sheet or the second computer terminal.

In embodiments, the digital line sheet may have a card authorization system connected to the microprocessor of the digital line sheet.

In embodiments, the display of the digital line sheet may be an ultra-thin liquid crystal display, a passive liquid crystal display, a flexible organic light emitting diode display, a light emitting polymer display, an organic electro-luminescence, an electronic paper display, a surface-conduction electron-emitter display, a field emission display or an electrochromic display.

In embodiments, a digital mannequin rendered by the digital line sheet or the second computer terminal, wherein the digital mannequin displays one or more of the showroom items.

In embodiments, one or more suggested showroom items may be rendered by the digital line sheet, wherein the one or more suggested showroom items is determined based on a location of the digital line sheet within the showroom, a user profile, or the information and/or multimedia data rendered by the digital line sheet.

In embodiments, the information and/or multimedia data indicative of the showroom items may include prices, suggested retail prices, color information, fabric information, season information, available colors, pantone numbers, color card information, digital color card examples, available sizes, manufacturing specifications, company contact information, sales representative contact information, style numbers, deliver dates, order cut-off dates, start ship dates complete ship dates, order minimums based on minimum per style or overall order minimums or digital pictures of the available items in one or more colors.

In embodiments, the system may have a user profile stored in the memory of the digital line sheet or within the first computer terminal, wherein the user profile includes personal information regarding one or more showroom items, the information and/or multimedia data, the vendor, the showroom or a user of the digital line sheet.

In another embodiment of the present invention, a method for displaying and managing showroom items in a showroom of a vendor is provided. The method may include a step of providing a digital line sheet having a display, a memory and a first wireless transducer connected to a microprocessor, wherein the digital line sheet accesses information and/or or multimedia data indicative of the showroom items of the vendor. Further the method may include the step of connecting the first wireless transducer of the digital line sheet to a first communication network, wherein the first communication network is a wireless communication network, wherein a first computer terminal is connected to the first communication network such that the digital line sheet communicates with the first computer terminal via the first communication network. Moreover, the method may include the step of automatically updating the information and/or multimedia data accessible by the digital line sheet, wherein the updated information and/or multimedia data is indicative of one or more available showroom items of the vendor.

In embodiments, the method may include the step of rendering the updated information and/or multimedia data indicative of the one or more available showroom items of the vendor.

In embodiments, the method may include the step of selecting a desired showroom item from the one or more available showroom items of the vendor.

In embodiments, the method may include the step of rendering the updated information and/or multimedia data for the desired showroom item.

In embodiments, the method may include the step of finalizing an order for the desired showroom item.

In embodiments, the method may include the step of inspecting the desired showroom item within the showroom of the vendor.

In embodiments, the method may include the step of identifying a location of the desired showroom item within the showroom of the vendor.

In embodiments, the method may include the step of detecting a location of the digital line sheet within the showroom of the vendor via a sensor, wherein the sensor is connectable to the first communication network and in communication with the first computer terminal via the wireless communication network.

In embodiments, the method may include the step of transmitting location directions from the first computer terminal to the digital line sheet, wherein the location directions are based on the location of the desired showroom item and a detected location of the digital line sheet.

In embodiments, the location directions may include a list of directions, instructions and/or a map illustrating directions from the detected location of the digital line sheet to the location of the desired showroom item in the showroom.

In embodiments, the method may include the step of transversing the showroom of the vendor to the location of the desired showroom item.

In embodiments, the method may include the step of connecting a second computer terminal to the first computer terminal via a second communication network, wherein the second computer terminal is remote with respect to the first computer terminal, the digital line sheet and the showroom of the vendor.

In embodiments, the method may include the step of rendering the updated information and/or multimedia data indicative of the one or more available showroom items via the second computer terminal.

In embodiments, the method may include the step of finalizing an order for one or more of the available showroom items of the vendor via the second computer terminal.

In embodiments, the method may include the step of accessing a user profile via the digital line sheet, the first computer terminal or the second computer terminal.

In embodiments, the user profile may include information indicative of a user, the updated information and/or multimedia data, the one or more available showroom items, the vendor or the showroom.

In embodiments, the method may include the step of transmitting an electronic notification from the first computer terminal to the digital line sheet or the second computer terminal.

In embodiments, the electronic notification may include information indicative of the one or more available showroom items, the updated information and/or multimedia data, a finalized order, the user profile, an event, a promotion or the vendor.

In embodiments, the method may include the step of creating a digital mannequin and displaying the one or more available showroom items or the desired showroom item on the digital mannequin.

In embodiments, the method may include the step of changing a pose of the digital mannequin from a first pose to a second pose.

In embodiments, the method may include the step of displaying the one or more available showroom items or the desired showroom item in one or more colors.

In embodiments, the method may include the step of rendering the updated information and/or multimedia data in multiple languages.

In embodiments, the method may include the step of rendering advertising media via the digital line sheet, the first computer terminal or the second computer terminal.

In embodiments, the method may include the step of submitting information into the user profile via the digital line sheet, the first computer terminal or the second computer terminal.

In embodiments, the method may include the step of determining a suggested showroom item based on the desired showroom item, a user profile, a detected location of the digital line sheet or the updated information and/or multimedia data for the one or more available showroom items.

In embodiments, the method may include the step of comparing the update information and/or multimedia data for the suggested showroom item and the desired showroom item.

In embodiments, the method may include the step of submitting information indicative of the suggested showroom item into the user profile.

In embodiments, the method may include the step of determining proximity between a location of the suggested showroom item and a location of the desired showroom item or a detected location of the digital line sheet.

In embodiments, the method may include the step of finalizing an order for the suggested showroom item.

In embodiments, the method may include the step of connecting a server and a database to the first computer terminal via a second communication network.

In embodiments, the display of the digital line sheet may be an ultra-thin liquid crystal display, a passive liquid crystal display, a flexible organic light emitting diode display, a light emitting polymer display, an organic electro-luminescence display, an electronic paper display, a surface-conduction electron-emitter display, a field emission display or an electrochromic display.

In embodiments, the information and/or multimedia data indicative of the showroom items may include prices, suggested retail prices, color information, fabric information, season information, available colors, pantone numbers, color card information, digital color card examples, available sizes, manufacturing specifications, company contact information, sales representative contact information, style numbers, deliver dates, order cut-off dates, start ship dates complete ship dates, order minimums based on minimum per style or overall order minimums or digital pictures of the available items in one or more colors.

In embodiments, the digital line sheet may have a scanning device connected to the microprocessor of the digital line sheet, wherein the microprocessor identifies a showroom item based on coded information associated with the showroom item and scanned by the scanning device.

It is, therefore, an advantage of the present disclosure to provide systems and methods for displaying and managing showroom items which may provide digital images and/or information indicative of current available showroom items and inventories via an electronic digital line sheet.

Another advantage of the present disclosure is to provide systems and methods for displaying and managing showroom items which may increase revenues and sales for the vendor by providing a convenient and easy to use an electronic digital line sheet for accessing item information indicative of the showroom items and identifying locations of the available items in a showroom.

And, another advantage of the present disclosure is to provide systems and methods for displaying and managing showroom items which may provide a wireless digital line sheet that connects to a terminal and a database for updating and configuring item information for showroom items so that users may traverse the showroom to identify and locate currently available items in a showroom.

A further advantage of the present disclosure is to provide systems and methods for displaying and managing showroom items which may maintain a user profile including user information regarding showroom items and personal information commenting on the showroom items.

Moreover, an advantage of the present disclosure is to provide systems and methods for displaying and managing showroom items which may allow a user to finalize an order for one or more showroom items via a wireless digital line sheet or a remote computer terminal of the user.

And, another advantage of the present disclosure is to provide systems and methods for displaying and managing showroom items which may create a digital mannequin displayable via a wireless digital line sheet and/or a remote computer terminal to simulate ensembles of showroom items in multiple colors.

Yet another advantage of the present disclosure is to provide systems and methods for displaying and managing showroom items which may suggest related showroom items to a user of a wireless digital line sheet based on showroom items of interest for the user and/or proximity from a desired showroom item in a showroom.

Another advantage of the present disclosure is to provide systems and methods for displaying and managing showroom items which may digitally display a showroom item in multiple colors without requiring production of physical samples in the multiple colors and photographs.

A still further advantage of the present disclosure is to provide systems and methods for displaying and managing showroom items which may provide electronic notifications to a user regarding desired showroom items, showroom items of interest from the showroom, finalized orders, upcoming promotions and/or future showrooms.

Yet another advantage of the present disclosure is to provide systems and methods for displaying and managing showroom items which may provide advertising media for displaying and rendering to a user via a wireless digital line sheet, a vendor computer terminal or a remote computer terminal of a user.

Additional features and advantages of the present disclosure are described in, and will be apparent from, the detailed description of the presently preferred embodiments and from the drawings.

### BRIEF DESCRIPTION OF THE DRAWINGS

FIG. 1 illustrates a block diagram of a wireless digital line sheet in accordance with the present disclosure;

FIG. 2 illustrates a block diagram of a system for displaying and managing showroom items in accordance with the present disclosure;

FIG. 3 illustrates a flow chart of a method for displaying and managing showroom items in accordance with the present disclosure; and

FIG. 4 illustrates a flow chart of a method for displaying and managing showroom items in accordance with the present disclosure.

### EMBODIMENTS

The present invention relates to systems and methods for managing showroom items of a vendor having a wireless electronic digital line sheet (hereinafter “line sheet”) connectible to a vendor computer terminal, a server and/or a database. The information displayable by the line sheet may be updated and/or configured by the vendor computer terminal in real-time to reflect available showroom items. The systems and methods may include a proximity sensor in communication with the line sheet to provide directions to locations of the available showroom items based on a detected location of the line sheet. A user of the line sheet may create and store a user profile within the database for maintaining and/or updating information indicative of the user and/or one or more showroom items. The line sheet may create a digital mannequin to simulate ensembles of the showroom items in multiple colors. The user may finalize an order for a showroom item via the line sheet or a remote computer terminal of the user. The user may create and/or build a digital user profile from the remote computer terminal of the user via a website of the vendor. An electronic notification and/or advertising media may be displayed and/or rendered via the line sheets, the vendor computer terminal and/or the remote computer terminal of the user.

In embodiments, the vendor may be a supplier of one or more goods and/or services (hereinafter “showroom items”). The vendor may manufacture inventoriable showroom items, and/or may sell the showroom items to a customer, such as the user of the line sheet. The vendor may or may not be a distributor of the showroom items via a showroom and may or may not be a manufacture of the showroom items. In embodiments, the showroom may be a vendor showroom, a corporate showroom or a temporary showroom at a trade show and/or like. The present disclosure should not be deemed as limited to a specific embodiment of the vendor and/or the showroom.

The showroom items may be, for example, durable goods and/or nondurable goods, or soft goods. In embodiments, the durable goods may include cars, appliances, business equipment, electronic equipment, home furnishings and fixtures, houseware and accessories, photographic equipment, recreational goods, sporting goods, toys, games and/or the like. In embodiments, the nondurable goods or soft goods may include cosmetics, food, cleaning products, fuel, office supplies, packaging and containers, paper and paper products, personal products, rubber, plastics, textiles, clothing, fashion accessories and footwear. In embodiments, the showroom may be a large space used to display and/or sell showroom items. In embodiments, the showroom items may be intermediate goods or producer goods which may be used as inputs in the production of other goods, such as partly finished goods or raw materials. The present disclosure should not be deemed as limited to a specific embodiment of the durable goods, the nondurable goods and/or the soft goods for the showroom items.

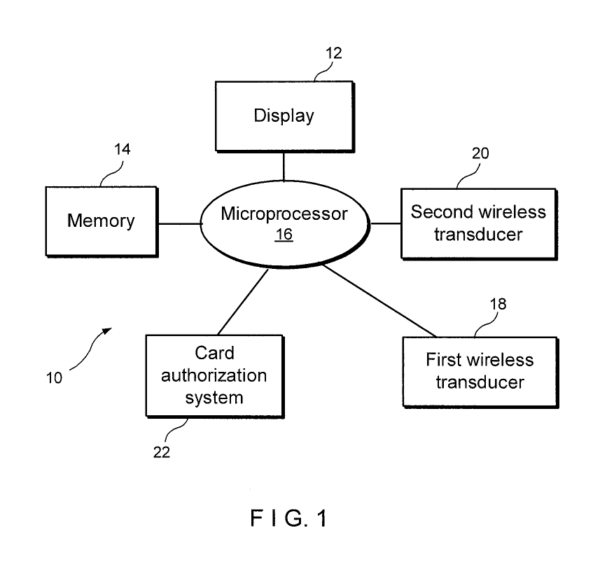

Referring now to the drawings wherein like numerals refer to like parts, FIG. 1 shows a wireless digital line sheet (hereinafter “line sheet 10”). The line sheet 10 may be a light-weight and/or ultra-thin wireless electronic media device, such as, for example, tablet personal computer (hereinafter “PC”), ultra-mobile PC, a mobile-based pocket PC, an electronic book computer, a laptop computer, a media player, a portable media device, a personal digital assistant, an enterprise digital assistant and/or the like. In embodiments, the line sheet 10 may be, for example, a 4G mobile device, a 3G mobile device, an ALL-IP electronic device, an information appliance or a personal communicator. The present disclosure should not be deemed as limited to a specific embodiment of the line sheet 10.

The line sheet 10 may have a display 12 for displaying or rendering information and/or multimedia data stored in a memory 14 of the line sheet 10. The display 12 of the line sheet 10 may be, for example, an ultra-thin liquid crystal display (hereinafter “LCD”), a passive LCD, a flexible organic light emitting diode (hereinafter “LED”), light emitting polymer or organic electro-luminescence, electronic paper (hereinafter “e-paper”), a surface-conduction electron-emitter display, a field emission display or an electrochromic display.

In embodiments, the display 12 of the line sheet 10 may be a touch-screen graphical user interface (hereinafter “touch-screen GUI”) or a digitized screen connected to a microprocessor 16 of the line sheet 10. The touch-screen GUI may be used in conjunction with a standard mechanical or an electromagnetic stylus (not shown in the drawings) to identify a specific position touched by a user (not shown in the figures) and may transfer the coordinates of the specific position to the microprocessor 16. The microprocessor 16 may obtain the information and/or multimedia data corresponding to the coordinates selected by the user from the memory 14 of the device 12. The display 12 and/or the line sheet 10 may display or render the selected information and/or the multimedia data to the user. The selected information and/or multimedia data may be indicative of one or more showroom items of the vendor (not shown in the figures).

In embodiments, the display 12 may have an electromagnetic induction panel installed on a surface of the display 12 which is connected to the microprocessor 16 of the line sheet 10. The electromagnetic stylus associated with the display 12 may emit an electromagnetic signal to induct a specified position on the electromagnetic induction panel, and an electromagnetic induction controller connected to the electromagnetic induction panel may calculate the coordinates corresponding to the specified position selected by the user. The electromagnetic induction controller may be connected to the microprocessor 16 which may transfer the coordinates to the microprocessor 16. The microprocessor 16 may obtain the information and/or multimedia data corresponding to the coordinates selected by the user from the memory 14 of the line sheet 10. As a result, the line sheet 10 may display or render the selected information and/or multimedia data to the user.

In embodiments, the display 12 may be a touchscreen which may be connected to the microprocessor 16 of the line sheet 10. The user may use one or more fingers or a stylus to select a specific position on the display 12 having coordinates which may be transferred to the microprocessor 16. As a result, the line sheet 10 may display or render the selected information and/or multimedia data to the user. The user may use one or more fingers to select information and/or multimedia data to be rendered via the display 12 and may use the stylus to perform handwriting functions such as making comments and/or notes.

In embodiments, the line sheet 10 may have a first wireless transducer 18 and/or a second wireless transducer 20 (hereinafter “wireless transducers 18, 20”) which may be connected to the microprocessor 16. The line sheet 10 may, optionally, have a card authorization system 22 connected to the microprocessor 16. In embodiments, the line sheet 10 may have an audio output device (not shown in the drawings) which may output or render audio data of the multimedia data stored in the memory 14 of the line sheet 10. The audio output device may include a speaker and/or an earphone interface device.

The first wireless transducer 18 may be, for example, a wireless sensor network device, such as, for example, a Wi-Fi network device, a wireless ZigBee device, an EnOcean device, an ultra-wideband device, a wireless Bluetooth device, a wireless Local Area Network (hereinafter LAN) accessing device, a wireless IrDA device and/or the like. In embodiments, the second wireless transducer 20 may be, for example, an infrared communication device, a radio frequency identification (hereinafter “RFID”) tag, a RFID reader, a Smart Card or a Smart Card reader. It should be understood that the wireless transducers 18, 20 may be any wireless transducers capable of connecting to a wireless communication network or capable of permitting the line sheet 10 to communicate with a wireless device as known to one of ordinary skill in the art.

The optional card authorization system 22 may authorize payment for the showroom item purchased from the vendor by credit card, charge card, debit card and/or the like. In embodiments, the optional card authorization system 26 may be, for example, a Speedpass transactional device or other transactional devices as known to one having ordinary skill in the art. The card authorization system 22 may allow the user to pay for the showroom item by submitting and completing a transaction for payment to the vender of the showroom item from an acquirer, such as a bank, financial institution and/or the like. The user may enter a personal identification number, a unique user identification and/or a user password for authorizing the transaction via display 14 of the line sheet 10. Upon completion of the transaction, the vendor of the showroom item may receive payment for the transaction from the acquirer. The line sheet 10 may be programmed with handwriting recognition software such that the user may electronically sign and authorize the transaction with the vendor.

In embodiments, the line sheet 10 may be programmed to provide a digital shopping cart function, a digital wish list function and/or a digital starred item function. The user may select one or more showroom items of the vendor that the user is interested in. As a result, the line sheet 10 may place the selected one or more showroom items in a digital shopping cart. The line sheet 10 may allow the user to purchase one or more of the showroom items in the digital shopping cart via a check out function which may be initiated as the user is leaving the showroom of the vendor and/or subsequently after the user has completed a visit to the showroom.

The user may designate one or more selected showroom items as desired items without placing the desired items in the digital shopping cart. As a result, the line sheet 10 may assign the desired items to a digital wish list which may be accessed, modified and/or examined by the user via the line sheet 10 and/or from the remote terminal 112 of the user via the website of the vendor. The digital wish list may be subsequently accessed by the user so that the user may purchase one or more desired items on the digital wish list via the line sheet 10 and/or from the remote terminal 112 of the user via the website of the vendor.

The digital starred item function of the line sheet 10 may allow the user to select and star or designate one or more of the showroom items within the digital shopping cart. As a result, the user may create and/or modify a subset of the showroom items within the digital shopping cart. The line sheet 10 may enable the user to select and/or purchase the subset of the showroom items.

In embodiments, the line sheet 10 may have one or more input components 24 and/or one or more indicator lights 26. The input components 24 may include, for example, a touch screen, a digital keyboard, a physical keyboard, one or more navigation buttons, a power button and/or a reset button. The indicator lights 26 may indicate whether power is on or off, a battery charge status, a proximity to one or more specific showroom items and/or a network communication status.

In embodiments, the input components 24 of the line sheet 10 may include a scanning device, such as an optical scanning device which may be capable of reading one or more tagged or coded information affixed to one or more showroom items. The line sheet 10 may determine and identify a showroom item based on the tagged or coded information scanned by the optical scanning device. The line sheet 10 may display and/or highlight the information associated with showroom item that was scanned by the optical scanning device. It should be understood that the scanning device may be any scanning device capable of reading tagged or coded information associated with one or more showroom items.

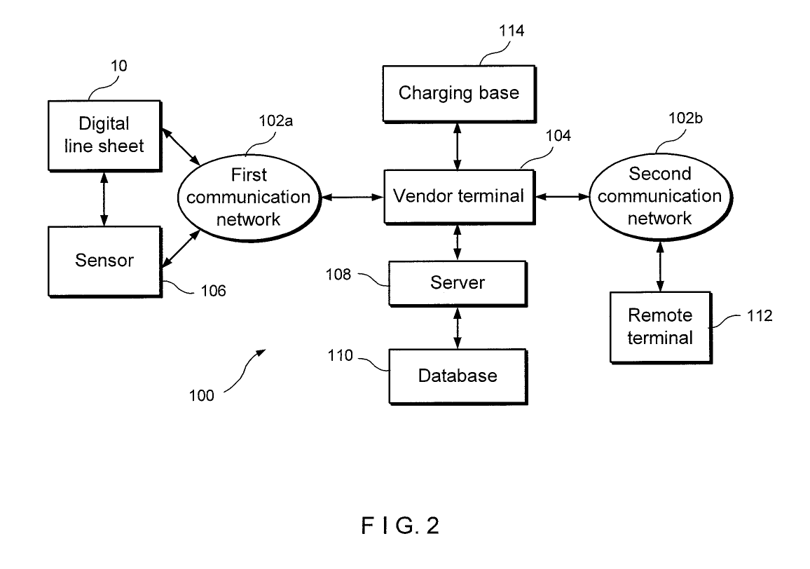

FIG. 2 illustrates a system 100 for displaying and managing the showroom items in accordance with the present disclosure. The system 100 may include the line sheet 10, a first computer network 102a (hereinafter “first network 102a”) and/or a second computer network 102b (hereinafter “second network 102b”). Further, the system 100 may have a primary vendor computer terminal 104a, a secondary vendor computer terminal 104b (hereinafter “terminals 104a, 104b”), a proximity sensor 106 (hereinafter “sensor 106”), a server 108, a database 110 of the server 108 and/or a remote computer terminal 112 (hereinafter “terminal 112”). The terminal 112 may be a user remote terminal or a vendor remote terminal. The present disclosure should not be deemed as limited to specific numbers of line sheets, users and/or remote computer terminals of the users which may access and/or may utilize the system 100.

The terminals 104a, 104b may be programmed with workstation/configuration software, automated communication software, account management software and/or digital mannequin software. The terminals 104a, 104b may be connected to each other via the first communication network 102a. As a result, the secondary vendor terminal 104b may communicate with the primary vendor terminal 104b via the first communication network 102a. In embodiments, the line sheet 10 and/or the terminal 112 may be programmed with the automated communication software and/or the digital mannequin software. Alternatively the terminals 104a, 104b may access software on the server 108 which may include the workstation/configuration, automated communication, account management and/or digital mannequin software.

A configuration and/or a format may be provided for displaying and/or rendering the information and/or multimedia data indicative of and/or associated with the showroom items via the terminal 104, the terminal 112 and/or the line sheet 10. The configuration and/or the format of the information and/or multimedia data may be based on templates provided by the workstation/configuration software. The configuration and/or the format of the information and/or multimedia data may be based on, designed by, arranged by and/or customized by one or more design elements which may be stored in the terminals 104a, 104b and/or the database 110 and accessed via the workstation/configuration software. In an embodiment, the one or more design elements may include a graphic, content, a color, text, a logo, a photograph, a surname, a quote, a trademark, a map, a slogan, a border, a wall paper, a pull-down option box and/or the like. It should be understood that the design elements may be any design element that may affect the configuration and/or the format of the information and/or multimedia data as known to one of ordinary skill in the art.

The terminals 104a, 104b may import and/or store digital images via the automated communication software. In embodiments, the terminals 104a, 104b may automatically communicate with the line sheet 10 and/or the terminal 112 over the first communication network 102a and/or the second communication network 102b (hereinafter “communication networks 102a, 102b”) via the automated communication software stored within the terminal 104. The terminals 104a, 104b may monitor, compile and review statistical data regarding usage of the line sheet 10, the terminal 114 and/or the system 100 via the account management software. The terminal 104, the line sheet 10 and/or the terminal 114 may create and/or may manipulate a digital mannequin for displaying one or more showroom items via the digital mannequin software.

Optionally, the system 100 may have a charging base 114 for electrically charging the line sheet 10. A portion (not shown in the figures) of the charging base 114 may be sized to receive the line sheet 10 or a portion of the line sheet 10, such that the line sheet 10 may be docked to the portion of the charging base 114. While docked to the charging base 114, the line sheet 10 may be electrically connected to a charging base 114 for electrically charging a rechargeable battery (not shown in the figures) of the line sheet 10. As a result, the rechargeable battery of the line sheet 10 may be charged by the charging base 114.

In embodiments, the charging base 114 may be digitally connectable to the terminals 104a, 104b. The charging base 114 may digitally connect the line sheet 10 to the terminals 104a, 104b such that the microprocessor 16 of the line sheet 10 may be in communication with the terminals 104a, 104b. The terminals 104a, 104b may update and/or synchronize the information and/or multimedia data stored in the memory 14 of the line sheet 10 to the updated information and/or multimedia data stored in the terminals 104a, 104b and/or the database 110. The line sheet 10 may be connected to the charging base 114 by a connector (not shown in the figures), such as a USB port and cable and/or the like. The present disclosure should not be deemed as limited to a specific embodiment of the connector of the charging base 114.

The line sheet 10 and/or terminal 112 may be local or remote with respect to the terminal 104, the server 108 and/or the database 110. The line sheet 10 may connect to and/or may access the first network 102a via the first wireless transducer 18 of the line sheet 10. The terminals 104a, 104b may be connected to the first network 102a, and the line sheet 10 may access the terminals 104a, 104b via the first network 102a and the first wireless transducer 18. As a result, the line sheet 10 may be in communication with the terminals 104a, 104b and may access information and/or multimedia data stored in the terminal 104.

The database 110, the server 108 and/or the primary vendor terminal 104a may be connected to the second communication network 102b. As a result, the terminals 104a, 104b may be in communication with the server 108 and may access information and/or multimedia data stored in the database 110 of the server 108 via the second communication network 102b. Additionally, the terminals 104a, 104b may access information and/or multimedia data stored in the database 110 via the server 108 and/or the second communication network 102b. In embodiments, the line sheet 10 may establish a secured wireless connection to the terminals 104a, 104b via the first network 102a.

The terminals 104a, 104b and the terminal 112 may be connected to the second network 102b. As a result, the terminal 112 may be in communication with the terminals 104a, 104b and may access the information and/or multimedia data stored in the terminals 104a, 104b via the second communication network 102b. Moreover, the terminal 112 may be connected to and in communication with the server 108. As a result, the terminal 112 may access the information and multimedia data stored in the database 110 via the second network 102b.

In embodiments, the networks 102a, 102b may be, for example, a personal area network (PAN), a local area network (LAN), a campus area network (CAN), a Metropolitan area network (MAN), a wide area network (WAN) and/or the like. The networks 102a, 102b may operate according to basic reference model, such as, for example, a four-layer Internet Protocol Suite model, a seven-layer Open Systems Interconnection reference model and/or the like. The present disclosure should not be deemed as limited to specific embodiment of the basic reference model.

In an embodiment, the networks 102a, 102b may be a wireless network, such as, for example, a wireless MAN, a wireless LAN, a wireless PAN, a Wi-Fi network, a WiMAX network, a global standard network, a personal communication system network, a pager-based service network, a general packet radio service, a universal mobile telephone service network, a radio access network and/or the like. It should be understood that the networks 102a, 102b may be any wireless network capable of connecting the microprocessor 16 of the line sheet 10 and/or the terminal 112 to the terminals 104a, 104b as known to one having ordinary skill in the art.

In an embodiment, the second network 102b may be a fixed network, such as, for example, an optical fiber network, an Ethernet, a cabled network, a permanent network, a power line communication network and/or the like. In an embodiment, the second network 102b may be a temporary network, such as, for example, a modem network, a null modem network and/or the like. In embodiments, the second network 102b may be an intranet, extranet or the Internet which may include the world wide web. The present disclosure should not be limited to a specific embodiment for the fixed network of the second network 102b.

The proximity sensor 106 may be located at a position with respect to the sheet line 10 and the first network 102a within the showroom of the vendor. For example, the proximity sensor 106 may be located on a wall, a fixture or a structure within the showroom of the vendor. Alternatively, the proximity sensor 106 may be incorporated directly into or affixed to one or more showroom items located within the showroom of the vendor. The proximity sensor 106 may connect to the first network 102a for accessing and communicating with the terminals 104a, 104b. The proximity sensor 106 may communicate with the line sheet 10 via the second wireless transducer 20 of the line sheet 10. The proximity sensor 106 may detect and identify the line sheet 10 via the second wireless transducer 20 of the line sheet 10. In embodiments, the proximity sensor 106 may detect or determine location data indicative of the location of the line sheet 10 within the showroom of the vendor.

The proximity sensor 106 may identify the location of the line sheet 10 within the showroom based on the location data of the line sheet 10 detected by the proximity sensor 106. The proximity sensor 106 may transmit the location data of the line sheet 10 to the terminals 104a, 104b via the first network 102a. The terminals 104a, 104b may determine and identify the location of the line sheet 10 within the showroom based on the location data of the line sheet 10 detected by the proximity sensor 106. The terminals 104a, 104b may store the location of the line sheet 10 within the showroom and/or the location data of the line sheet 10 in the database 110 of the server 108. In embodiments, one or more proximity sensors (not shown in the figures) may track and/or monitor the location of the line sheet 10 as the user transverses the showroom with the line sheet 10 to view, inspect and/or purchase one or more showroom items within the showroom.

The proximity sensor 106 may record a path of the line sheet 10 within the showroom of the vendor and an amount of time that a line sheet 10 may be located at a location within the showroom of the vendor. The proximity sensor may communicate path and/or time information for the line sheet 10 to the terminals 104a, 104b. The path and/or time information may be analyzed by the terminals 104a, 104b to improve marketing of the showroom to a user of the line sheet 10.

In embodiments, the proximity sensor 106 may be a wireless sensor network device, an infrared communication device, a RFID tag, RFID reader, a Smart Card or a Smart Card reader. In embodiments, the proximity sensor 106 may be, for example, an ultrasonic position sensor, an optical position sensor or an electromagnetic position sensor. A technology of the proximity sensor 106 may be based on, used in conjunction with or complimentary to a technology of the second wireless transducer 20. It should be understood that the proximity sensor 106 may be any device that may be capable of detecting and communicating with the second wireless transducer 20 of the line sheet 10 as known to one of ordinary skill in the art.

The information and/or multimedia data stored in and accessible from the memory 14 of the line sheet 10 may be preloaded into the memory 14. Alternatively, the information and/or multimedia data may be stored in the terminals 104a, 104b and/or the database 110 which may be accessed by the terminals 104a, 104b and/or the terminal 112 via the networks 102a, 102b. As a result, the line sheet 10 and/or the terminal 112 may download the information and multimedia data from the terminals 104a, 104b. The line sheet 10 and/or the terminal 112 may render the information and/or multimedia data to the user.

Moreover, the line sheet 10 may store the information and/or multimedia data in the memory 14 of the line sheet 10 or the terminal 112 may store the information and/or multimedia data therein. The line sheet 10 and/or the terminal 112 may not render the information and/or multimedia data until the information and/or multimedia data is completely or substantially completely received from the terminals 104a, 104b and/or the server 108. Alternatively, the line sheet 10 and/or the terminal I 12 may utilize streaming media technology to simultaneously download and render the information and/or multimedia data.

The line sheet 10 and/or the terminals 104a, 104b may be programmed with software for determining a usage state of line sheet 10. The line sheet 10 may be updated based on the determined usage state of the line sheet 10. The usage state of the line sheet 10 may be determined based on information from one or more sensors on the line sheet 10, one or more sensors in the showroom and/or one or more sensors in the charging base 114. For example, a motion sensor within the line sheet 10, a proximity sensor in the showroom and/or a sensor within the charging base 114 may determine the usage state of line sheet 10, such as whether the line sheet 10 is being used by the user in the showroom or whether the line sheet is not in use and/or being stored in the charging base 114. The terminals 104a, 104b may transmit one or more types of content updates to the line sheet 10 based on the usage state of line sheet 10.

The information and/or multimedia data may be displayed and/or rendered to the user via the display 12 and/or the audio output device of the line sheet 10 or the terminal II 2 of the user. The information and/or multimedia data may relate to and be indicative of one or more showroom items offered by the vendor. The information and/or multimedia data may include text, images, sound, music, or video indicative of and associated with the showroom items offered by the vendor. The information and/or multimedia data may be displayed or render in one or more languages which may be selectable by the user. The user may select which language(s) for displaying or rendering the information and/or multimedia data when creating the user profile and/or during an initial registration of the digital user profile with the vendor. Moreover, prices of showroom items may be displayed in one or more currencies which may be selectable by the user during creation of the user profile or initial registration of the user profile. The present disclosure should not be deemed as limited to a specific embodiment of the information and/or multimedia data.

In embodiments, the information and/or multimedia data for the showroom items may include current and updated item information associated with and/or indicative of current showroom items available and offered for sale by the vendor. The information and/or multimedia data stored in the line sheet 10, terminals 104a, 104b and/or the database 110 may also include item information indicative of showroom items that are no longer offered for sale by the vendor. Further, the item information and/or multimedia data may include, for example, a digital product matrix and styles, such as pictorial descriptions of styles. In embodiments, the pictorial descriptions of styles may include line drawings, sketches, computer generated sketches, photographs and/or style pictures associated with and indicative of the showroom items.

Further, the item information for the showroom items may include, for example, prices, suggested retail prices, color and/or fabric information, season information, available colors, pantone numbers, color card information or digital color card examples, available sizes, manufacturing specifications and/or the like. Still further, the item information for the showroom items may include company and/or sales representative contact information, style numbers, deliver dates, order cut-off dates, start ship dates complete ship dates and/or order minimums, such as minimum per style and/or overall order minimums. Moreover, the item information may include, for example, digital pictures of the available items in multiple colors and/or the like. It should be understood that the item information for the showroom items may be any information which may be indicative of the showroom items as known to one of ordinary skill in the art.

The line sheet 10, the terminals 104a, 104b and/or the terminal 112 may be programmed with software to provide a digital search engine program for searching the information and/or multimedia data for the showroom items stored in the terminals 104a, 104b and/or the database 110. The digital search engine program may search the information and/or multimedia data to identify and display item information for one or more showroom items of the vendor. The user may enter one or more words or phrases associated or indicative of the item information for the showroom items into the digital search engine program via the line sheet 10, the terminals 104a, 104b and/or the terminal 112. The digital search engine program may match the entered word(s), phrase(s) and/or pricing info with item information for one or more showroom items and display the matching results via the line sheet 10, the terminals 104a, 104b and/or the terminal 112.

The line sheet 10 may provide the user with the capability to sort the showroom items based on a user criteria, such as, for example, prices, available colors, item types, user generated ratings, items with or without comments and/or the like. In embodiments, the searching and/or sorting capabilities of the line sheet 10 may be implemented such that the user may view or hide one or more of the showroom items that do or do not match the user criteria. The searching and sorting capabilities may be available to the user via the line sheet 10, the terminals 104a, 104b and/or the terminal 112.

In embodiments, the line sheet 10, the terminals 104a, 104b and/or the terminal 112 may access, download and/or render advertising media stored in the terminals 104a, 104b the first network 102a. Alternatively, the server 108 may automatically transmit advertising media stored in the database 110 to terminals 104a, 104b and/or the terminal 112 via the automated communication software programmed into the terminals 104a, 104b and/or the terminal 112. Additionally, the terminals 104a, 104b may access advertising information from a third party vendor and render the advertising information to the user via the line sheet 10. In embodiments, the terminals 104a, 104b may automatically transmit the advertising media and/or advertising media to the line sheet 10 and/or the terminal 112 via the automated communication software programmed into the terminals 104a, 104b. It should be understand that any standard Internet advertising methods may be rendered by the line sheet 10, the terminals 104a, 104b and/or the terminal 112.

The advertising media may be, for example, a commercial, an advertisement, an audio transmission, a video, an interview, a commentary, a documentary and/or the like. In embodiments, the advertising media may relate to and be indicative of an entity, such as, for example, a corporate entity, a marketing agency, a media distributor, a consumer products producer, an advertising agency, a manufacturer, a government agency, a travel corporation, an entertainment corporation and/or the like. The present disclosure should not be limited to a specific embodiment of the entity associated with the advertising media. It should be understood that the advertising media may be any type of advertising media as known to one of ordinary skill in the art.

In embodiments, the line sheet 10, the terminals 104a, 104b and/or the terminal 120 may access, download and/or render digital media files stored in the terminals 104a, 104b and/or the database 110. The digital media files may include, for example, electronic mail, audio signals, still images, video frames, data feeds, data streams, program guides, text information, musical compositions, radio programs, audio books, audio programs, cable television programs, satellite television programs, public access programs, motion pictures, animated works, music videos, animated works, video programs, video games and/or soundtracks and/or video tracks of audiovisual works. In an embodiment, the audiovisual works may be, for example, dramatic works, film scores, operas, performances, concerts, plays, operettas, ballets, musicals, circus acts and/or the like. The present disclosure should not be deemed as limited to a specific embodiment of the digital media files.

In embodiments, a user may seek a vendor to purchase one or more showroom items. The vendor may have a showroom for displaying the one or more showroom items. The user may enter the showroom of the vendor to browse, inspect, view and/or purchase the one or more showroom items in the showroom of the vendor. The vendor may distribute the line sheet 10 to the user so that the user may view and/or examine information and/or multimedia data for the one or more showroom items. The information and/or multimedia data may be indicative of the showroom items and may be rendered to the user via the line sheet 10. The advertising media and/or digital media may also be rendered to the user of the line sheet 10.

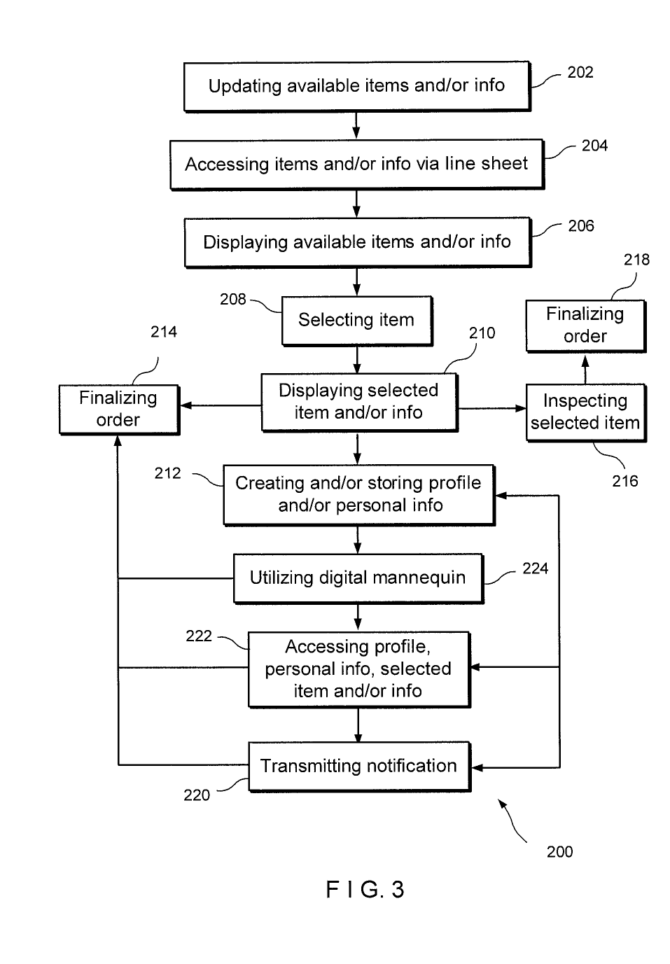

FIG. 3 illustrates a method 200 for displaying and managing showroom items in accordance with the present disclosure. The vendor may update and/or synchronize the information and/or multimedia data stored in the line sheet 10 via the terminals 104a, 104b and/or first network 102a to accurately reflect the current and available showroom items of the vendor as shown at step 202. The microprocessor 16 of the line sheet 10 may store the updated information and/or multimedia data in the memory 14 of the line sheet 10. The line sheet 10 may access the updated information and/or multimedia data indicate of the current and available showroom items which may be stored in the memory 14 of the line sheet 10 as shown at step 204. The audio output device and/or the display 12 of the line sheet 10 may display and render the updated information and/or multimedia data to the user of the line sheet 10 as shown at step 206. It should be understood that any function performed by the terminals 104a, 104b of the vendor may be performed by the vendor remotely via the terminal 112.

The user may search, identify and/or select a desired available showroom item (hereinafter “desired item”) and/or items of interest from the available showroom items of the vendor via the line sheet 10 as shown at step 208. The audio output device and/or the display 12 of the line sheet 10 may display and render multi-linguistic texts, audio and video to users for the updated information and multimedia data indicative of the available showroom items, the desire item and/or the items of interest as shown at step 210. Optionally, the line sheet 10 may access and render the advertising media or information to the user while the user is utilizing the line sheet 10. Optionally, the user may, at any time, use the card authorization system 22 to authorize one or more transactions to pay for an order of at least one desired item. The user may create, save and/or access the user profile of the user via the line sheet 10 to enter, update, submit and/or store personal information in the user profile of the user regarding the available showroom items, the items of interest and/or the desired item as shown at step 212. The personal information in the user profile of the user may or may not be confidential to the vendor. The user may prepare and/or finalize an order for the available showroom items, the items of interest and/or the desired item via the line sheet 10 as shown at step 214.

In embodiments, the user may desire to physically view and/or inspect the items of interest or the desired item prior to finalizing an order for the items of interest and/or the desired item. The user may request the location of the items of interest and/or desired item within the showroom of the vendor via the line sheet 10. The terminals 104a, 104b may transmit the location of the items of interest and/or the desired item to the line sheet 10 via the first network 102a. The user may identify the location of the items of interest and/or the desired item and may visit the location to physically view and/or inspect the items of interest and/or the desired item based on the location transmitted from the terminals 104a, 104b as shown at step 216. In embodiments, the terminals 104a, 104b may provide directions to the line sheet 10 for traversing the showroom to arrive at the location of the items of interest and/or the desired item. The user may prepare and/or finalize the order based on the physical inspection of the items of interest and/or the desired item as shown at step 218.

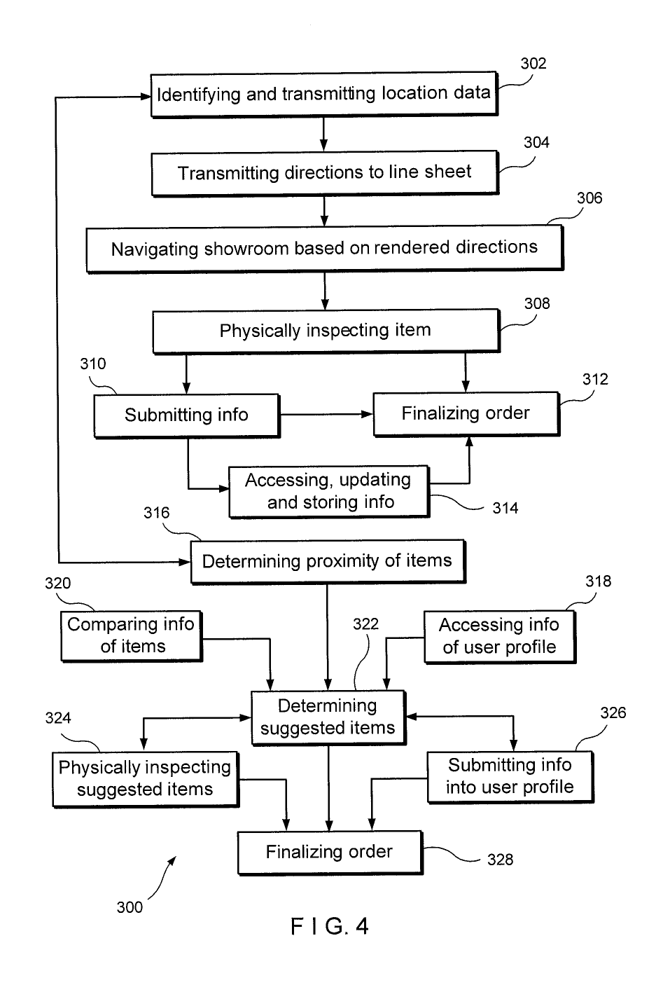

FIG. 4 illustrates a flow chart of a method for displaying and managing showroom items in accordance with the present disclosure. In embodiments, the terminals 104a, 104b may determine that the line sheet 10 is being moved or utilized by the user within the showroom via the second transducer 20, the proximity sensor 106 and/or the second network 102a as shown at step 302. The proximity sensor 106 may identify and transmit the location data of the line sheet 10 to the terminals 104a, 104b via the first network 102a. The terminals 104a, 104b may identify the location of the line sheet 10 within the showroom and/or a path of the line sheet through the showroom based on the location data detected by the proximity sensor 106. Alternatively, the line sheet 10 may determine the location of the line sheet 10 and transmit the location data to the terminals 104a, 104b via the first network 102a. The terminals 104a, 104b may store the location data and/or the location of the line sheet 10 therein or within the database 110.

The terminals 104a, 104b may transmit the directions in the form of, for example, a list of directions, instructions and/or a map illustrating directions from the detected location of the line sheet 10 to the location of the items of interest and/or the desired item as shown at step 304. As a result, the user may navigate the showroom from the detected location of the line sheet 10 to the location of the items of interest and/or the desired item within the showroom based on the directions rendered by the line sheet 10 as shown at step 306. The user may physically inspect the items of interest and/or the desired item as shown at step 308 and/or may enter the personal information regarding the items of interest and/or the desired item into user profile of the user via the line sheet 10 as shown at step 310. Alternatively, the line sheet 10 may display or highlight items that are presently located within close proximity to the line sheet 10 within the showroom. In embodiments, the user may prepare and finalize an order for the items of interest and/or the desired item as shown at step 312 after physically inspecting the items of interest and/or the desired item or after submitting the personal information into the user profile via the line sheet 10. The present disclosure should not be deemed as limit to a specific embodiment of the form of the directions rendered by the line sheet 10 to the user.

In embodiments, the user may subsequently view, update, store and/or delete the personal information regarding the items of interest and/or the desired item of the user profile via the terminal 112 as shown at step 314. The user may or may not prepare and/or finalize the order via the terminal 112 during a subsequent viewing of the user profile or via the line sheet 10 based on the personal information stored within the user profile as shown at step 312.

In embodiments, the terminals 104a, 104b may determine one or more suggested showroom items (hereinafter “suggested items”) based on the location data of the items of interest and/or the desired item as shown at step 316, a comparison of the information and/or multimedia data indicative of the items of interest and/or the desired item as shown at step 320 and/or the personal information within the user profile as shown at step 318. The suggested items may be located within a proximity to the location of the items of interest and/or the desired item or may have common characteristics with the items of interest and/or the desired item. A distance between the locations of the suggested items and the items of interest and/or the desired item may be, for example, 10 feet, 20 feet, 50 feet or 100 feet. The present disclosure should not be deemed as limited to a specific embodiment of the distance between the locations of the suggested items and the items of interest and/or the desired item.

The terminals 104a, 104b may compare the information and/or multimedia data indicative of the items of interest and/or the desired item and other available showroom items to determine and identify the common characteristics between the suggested items and the items of interest and/or the desired item. The terminals 104a, 104b may identify the suggested items based on the common characteristics and transmit the identity of the suggest items to the line sheet 10 for rendering to the user.

The terminals 104a, 104b may determine and transmit the suggested items to the line sheet 10 via the first network 102a as shown at step 322. The terminals 104a, 104b may also transmit the locations of the suggested items to the line sheet 10, with or without directions to the suggested items. As a result, the user may locate and physically inspect the suggested items within the showroom as shown at step 324. The user may prepare and/or finalize an order for one or more suggested items via the line sheet 10 within the showroom as shown at step 328.

Alternatively, the user may view the information and/or multimedia data for the suggested items while viewing the user profile via the terminal 112 of the user over the second network 102b. Personal information regarding and/or indicative of the suggested items may be submitted into the user profile by the user via the line sheet 10 as shown at step 326. The user may prepare and/or finalize the order for the suggested items via the terminal 112 of the user with or without submitting personal information into the user profile or physically inspecting the suggested items as shown at step 328.

The user may, optionally, call the vendor or an employee of the vendor to provide incidental services, such as, for example, verbal directions to the desired item, verbal information associated with the items of interest and/or the desired item and/or the like. The user may call the vendor and/or the employee by transmitting a call signal from the line sheet 10 to the terminals 104a, 104b. Additionally, the terminals 104a, 104b may transmit an order status for the order of the desired item to the user via terminal 112 and/or the line sheet 10. The line sheet 10 and/or the terminal 112 may calculate and display a running bill total for one or more orders for one or more suggested items, items of interest and/or desired items.

In embodiments, the terminals 104a, 104b may transmit one or more electronic notifications to a user via the line sheet 10 or the terminal 12 as shown at step 220. The electronic notifications may be indicative of or associated with one or more desired items, the items of interest, the suggested items, one or more finalized orders, upcoming promotions and/or future showrooms. Moreover, the electronic notification may be based on information in the user profile and/or personal information regarding one or more desired items, the items of interest and/or the suggested items. After receiving and accessing the electronic notifications, the user may finalize the order for one or more desired items, the items of interest and/or the suggested items as shown at step 214. The present disclosure should not be deemed as limit to a specific embodiment of the electronic notifications.

In embodiments, the user may subsequently access the user profile and/or the personal information stored in the user profile as shown at step 222. The user may access the user profile and/or the personal information stored therein via the line sheet 10 and/or the terminal 112. After subsequently accessing the user profile and/or personal information stored therein, the user may finalize the order for one or more desired items, the items of interest and/or the suggested items as shown at step 214.

In embodiments, the line sheet 10 and/or the terminal 112 may display the suggested items, the items of interest and/or the desired item in a first color, such as, for example, red. The line sheet 10 may be programmed to or capable of changing the first color to a second color and displaying the suggested items, the items of interest and/or the desired item in the second color. As a result, the user may view the suggested items, the items of interest and/or the desired item in multiple colors, such as, for example, red, black, white and/or the like. By digitally displaying the suggested items, the items of interest and/or the desired item via the line sheet 10 and/or the terminal 112 in multiple colors, the vendor may not have manufacture multiple physical samples and/or photos of the suggested items, the items of interest and/or the desired item. The present disclosure should not be deemed as limited to a specific embodiment of the first color, the second color and/or the multiple colors of the suggested items, the items of interest and/or the desired item.

In embodiments, the line sheet 10 and/or the terminal 112 may be programmed and/or capable of creating and displaying one or more digital mannequins which may simulate ensembles comprised of the suggested items, the items of interest and/or the desired item as shown at step 224. The user may select one or more mannequin items from the multiple colors of the suggested items, the items of interest and/or the desired item and cloth one or more digital mannequins with one or more mannequin items. Further, the mannequin items may be displayed on one or more digital mannequins in the first color, the second color and/or the multiple colors.

The one or more digital mannequins may include digital mannequins having one or more styles, such as, for example, different body types, different skin color and/or the like. The user may select one or more digital mannequins from the one or more styles of digital mannequins when creating the user profile or during the initial registration of the user profile. The line sheet may enable the user to change which style of digital mannequin is rendered to the user of the line sheet 10 to display the one or more mannequin items on one or more digital mannequins having one or more different styles. The user may store a set one or more digital mannequins having one or more different styles in the user profile as, for example, favorite digital mannequins. As a result, the user may easily access a digital mannequin having a specific body type from the set of favorite digital mannequins stored in the user profile to display one or more showroom items on the digital mannequin having the specific body type.

The line sheet 10 and/or the terminal 112 may be programmed to and/or capable of manipulating the digital mannequin to change a first pose of the digital mannequin to a second pose. In embodiments, the line sheet 10 and/or the terminal 112 may be programmed to and/or capable of animating the digital mannequin such that the digital mannequin may be in motion and/or static. The user may store the digital mannequin and/or the mannequin items within the user profile of the user via the line sheet 10 and/or the terminal 112. The user may prepare and finalize an order for one or more colors of the suggested items, the items of interest and/or the desired item via the line sheet 10 and/or the terminal 112 based on the digital appearance of the digital mannequin wearing the selected mannequin items as shown at step 218.

In embodiments, the line sheet 10 may communicate with other line sheets (not shown in the figures) via the second transducer 20 of the line sheet 10 or via the first network 102a and the first transducer 18 of the line sheet 10. The user may transmit user communications regarding the vendor, the available showroom items and/or the desired item to the other line sheets. The user communications may include text messages, instant messages, notes, comments, reviews, rating information and/or the like. The present disclosure should not be deemed as limited to a specific embodiment of the user communications transmittable via the line sheet 10.

The system 100 may determine usage information for the line sheet 10. The line sheet 10 and/or the terminals 104a, 104b may count and determine how many times and/or how often the line sheet 10 was activated and/or utilized by one or more users during a duration of time, such as, for example, one (1) hour, twelve (12) hours, one (1) week, one (1) month or one (1) year. The terminals 104a, 104b may store the usage information for the line sheet 10 therein or within the database 110. The present disclosure should not be deemed as limited to a specific embodiment of the duration of time.

It will be appreciated that several of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A system for displaying and managing showroom items in a showroom of a vendor, the system comprising:
a first computer terminal connected to a first communication network, wherein the first communication network is a wireless communication network, wherein the first computer terminal is programmed with automatic updating software and accesses information and/or multimedia data indicative of the showroom items; and
a digital line sheet having a display, a memory and a first wireless transducer connected to a microprocessor, wherein the first wireless transducer is connectable to the first communication network such that the digital line sheet communicates with the first computer terminal via the first communication network, wherein the display of the digital line sheet renders the information and/or multimedia data received from the first computer terminal over the wireless communication network.

2. The system according to claim 1 further comprising:
a second computer terminal connected to the first computer terminal via a second communication network, wherein the second computer terminal is remote with respect to the first computer terminal and the digital line sheet.

3. The system according to claim 1 further comprising:
a sensor located within the showroom of the vendor and connected to the first communication network, wherein the sensor detects a location of the digital line sheet within the showroom of the vendor.

4. The system according to claim 3 further comprising:
a second wireless transducer connected to the microprocessor of the digital line sheet, wherein the second wireless transducer communicates with the sensor within the showroom of the vendor.

5. The system according to claim 4, wherein the second wireless transducer and/or the sensor is selected from the group consisting of an infrared communication device, a radio frequency identification tag, radio frequency identification reader, a Smart Card and a Smart Card reader.

6. The system according to claim 1 further comprising:
a server and a database in communication with the first computer terminal via a second communication network.

7. The system according to claim 2 further comprising:
advertising media accessible by the first computer terminal, wherein the advertising media is rendered by the digital line sheet, the first computer terminal or the second computer terminal.

8. The system according to claim 1 further comprising:
location directions for a showroom item within the showroom transmittable from the first computer terminal to the digital line sheet via the first communication network.

9. The system according to claim 2 further comprising:
an electronic notification transmittable from the first computer terminal to the digital line sheet or the second computer terminal, wherein the electronic notification is indicative of one or more showroom items, a finalized order, a user profile, an event, a promotion or the vendor.

10. The system according to claim 2 further comprising:
a finalized order for one or more showroom items, wherein the finalized order is transmittable to the first computer terminal from the digital line sheet or the second computer terminal.

11. The system according to claim 1, wherein the digital line sheet has a card authorization system connected to the microprocessor of the digital line sheet.

12. The system according to claim 1, wherein the display of the digital line sheet is selected from the group consisting of an ultra-thin liquid crystal display, a passive liquid crystal display, a flexible organic light emitting diode display, a light emitting polymer display, an organic electro-luminescence, an electronic paper display, a surface-conduction electron-emitter display, a field emission display and an electrochromic display.

13. The system according to claim 2 further comprising:
a digital mannequin rendered by the digital line sheet or the second computer terminal, wherein the digital mannequin displays one or more of the showroom items.

14. The system according to claim 1 further comprising:
one or more suggested showroom items rendered by the digital line sheet, wherein the one or more suggested showroom items is determined based on a location of the digital line sheet within the showroom, a user profile, or the information and/or multimedia data rendered by the digital line sheet.

15. The system according to claim 1, wherein the information and/or multimedia data indicative of the showroom items includes prices, suggested retail prices, color information, fabric information, season information, available colors, pantone numbers, color card information, digital color card examples, available sizes, manufacturing specifications, company contact information, sales representative contact information, style numbers, deliver dates, order cut-off dates, start ship dates complete ship dates, order minimums based on minimum per style or overall order minimums or digital pictures of the available items in one or more colors.

16. The system according to claim 1 further comprising:
a user profile stored in the memory of the digital line sheet or within the first computer terminal, wherein the user profile includes personal information regarding one or more showroom items, the information and/or multimedia data, the vendor, the showroom or a user of the digital line sheet.

17. The system according to claim 8, wherein the location directions include a list of directions, instructions and/or a map illustrating directions from the detected location of the digital line sheet to the location of the desired showroom item in the showroom.

18. The system according to claim 13 further comprising:
means for changing a pose of the digital mannequin from a first pose to a second pose.

19. The system according to claim I further comprising:
means for determining proximity between a location of a suggested showroom item and a location of a desired showroom item or a detected location of the digital line sheet.

20. The system according to claim 1, wherein the digital line sheet has a scanning device connected to the microprocessor of the digital line sheet, wherein the microprocessor identifies a showroom item based on coded information associated with the showroom item and scanned by the scanning device.
